(19) United States
(12) Patent Application Publication
(10) Pub. No.: US 2010/0211649 A1
(43) Pub. Date: Aug. 19, 2010

(54) Method and System for Sending Message with Geographic Reference

(75) Inventors: Paulo Dimas, Lisboa (PT); Sampo Kellomäki, Lisboa (PT); Stanley Kugell, Newton, MA (US)

Correspondence Address: Rahman LLC, 10025 Governor Warfield Parkway, Suite 110, Columbia, MD, 21044, US

(73) Assignee: TIME BI, SA, Lisboa (PT)

(21) Appl. No.: 12/707,216

(22) Filed: Feb. 17, 2010

(30) Foreign Application Priority Data
Feb. 17, 2009 (IN) 337/CHE/2009

(51) Int. Cl. G06F 15/16

(52) U.S. Cl. 709/206

(57) ABSTRACT

Methods and systems for sending messages with a location token as a geographic location reference. A method for sending a message with location token from a sending station in a communications network, where user initiates a request by selecting a location, the sending station sends a request to a server for location token for the location selected by the user, the server generates a location token and returns the location token to the sending station, the sending station creates and sends the message with the location token sent by the server, a receiving station receives the message along with location token, user operating the receiving station requests the server to retrieve location by accessing the location token. The capabilities of the server may be co-hosted wholly or partially on the sending station, wholly or partially on the receiving station, or wholly or partially on both the sending and receiving station.

### TECHNICAL FIELD

The embodiments herein generally relate to sharing geographic location information, and, more particularly, to including geographic location reference in a message to be sent in a communication network.

### BACKGROUND

Currently, SMS, email, instant messages, and other messages can be used to send descriptive information about a geographic location, such as an address. This is done for various purposes such as arranging a meeting location, explaining where a person is located, or for other purposes. Typically the geographic location information is typed manually by the user, for example by typing a descriptive street address, place name, latitude/longitude, or other geographic reference. In other instances, a machine-readable geographic reference, such as a URL, from an internet mapping service may be manually retrieved by entering geographic information into an internet browser, and the user may manually copy and paste the URL from its source into a separate application for messaging. In still other instances, a web site can be directed to send such a reference by email or other messaging means.

Since the geographic location information is typically typed or manipulated by the user and may be lengthy, the process of acquiring the information and typing/manipulating such information requires the use of several different application programs, and, therefore, becomes difficult, error-prone, may require advanced skill levels, and may not function well, especially on mobile platforms (due to accessibility and switching of applications and message length restrictions). Therefore, the results are often subject to multiple interpretations. Further, the information may be truncated because the information (such as a URL from an internet map service) length may be too long. For the recipient, the information is often difficult to understand, subject to multiple interpretations, and may not provide clear guidance about the location referenced.

### BRIEF DESCRIPTION OF DRAWINGS

The embodiments herein will be better understood from the following description with reference to the drawings, in which:

FIG. 1 is a block diagram illustrating a system for sending a message along with a location token according to an embodiment herein;

FIG. 2 is a flow diagram illustrating a method of sending a message along with a location token according to an embodiment herein;

FIG. 3 is a flow diagram illustrating a method of sending a message along with a location token according to an embodiment herein;

FIG. 4 is a block diagram illustrating a system for sending a message along with a location token according to an embodiment herein;

FIG. 5 is a flow diagram illustrating a method of sending a message along with a location token according to an embodiment herein;

FIG. 6 is a block diagram illustrating a system for sending a message along with a location token according to an embodiment herein;

FIG. 7 is a flow diagram illustrating a method of sending a message along with a location token according to an embodiment herein; and

FIGS. 8 to 12 illustrate an example implementation according to various embodiments herein.

### DETAILED DESCRIPTION OF EMBODIMENTS

The phrase “location token” as used throughout the specification refers to a geographic location reference. A location token may be in the form of or a combination of a random string that may be used as a key to store the referenced location in a database, a URL that may be used to access the location information using a custom application or an application like a web browser, an encoded string that might contain information about the referenced location (like latitude/longitude information, place of interest) and/or information about user (like user name) in part or in whole or in any combination thereof, including in a tightly compressed, compacted and/or encrypted form, and a descriptive string that may be obvious or non-obvious in referring to a particular geographic location.

The phrase “sending station” as used throughout the specification refers to any station (or end user device) that is used as a station to send a message. The phrase “receiving station” as used throughout the specification refers to any station that is used as a station to receive a message. Wherever appropriate, a sending station may also be used as a receiving station, and a receiving station may also be used as a sending station.

Referring to a station only as a sending station or as a receiving station may be done for illustrative purpose only and should not be considered a limitation of the station itself. Sending stations and receiving stations are stations that are computing devices capable of sending and receiving messages in communication networks unless otherwise mentioned. For example, a station may be a personal computer in a computer network. In another example, a station may be a mobile communication device in a cellular network.

The phrases “communication network,” “network,” and “telecommunication network” are used interchangeably throughout the specification, and, in general, refer to any communication network through which devices may send and receive messages that are capable of carrying a location token. A network may refer to computer networks through which computing devices may exchange messages in the form of emails, instant messages and various other messaging formats (provided by various services providers). A network may refer to a network of networks like the Internet. A network may refer to a telecommunication network like a cellular network through which mobile devices may send and receives messages in form of SMS, MMS and so on. A network may also refer to a communication network like a peer to peer network using which sending stations and receiving stations may communicate with each other. Examples may be illustrated using a specific type of network and a specific type of messaging format. Examples should not be construed as limiting the scope of the embodiments herein.

A “message” is any message capable of carrying a geographic location token using which a user receiving such a message will be able to access the referenced geographic location. Some examples of a message include email, instant message, SMS, MMS, and various other messaging formats provided by service providers (like social media platforms) on the Internet.

“Deferencing” may mean obtaining location information using a location token as a key in a database. Dereferencing may also mean decoding an encoded location token to obtain a key that may further be used to obtain location information from a database. Dereferencing may also mean decoding an encoded location token to obtain location information, where location token itself comprises of location information in encoded format.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

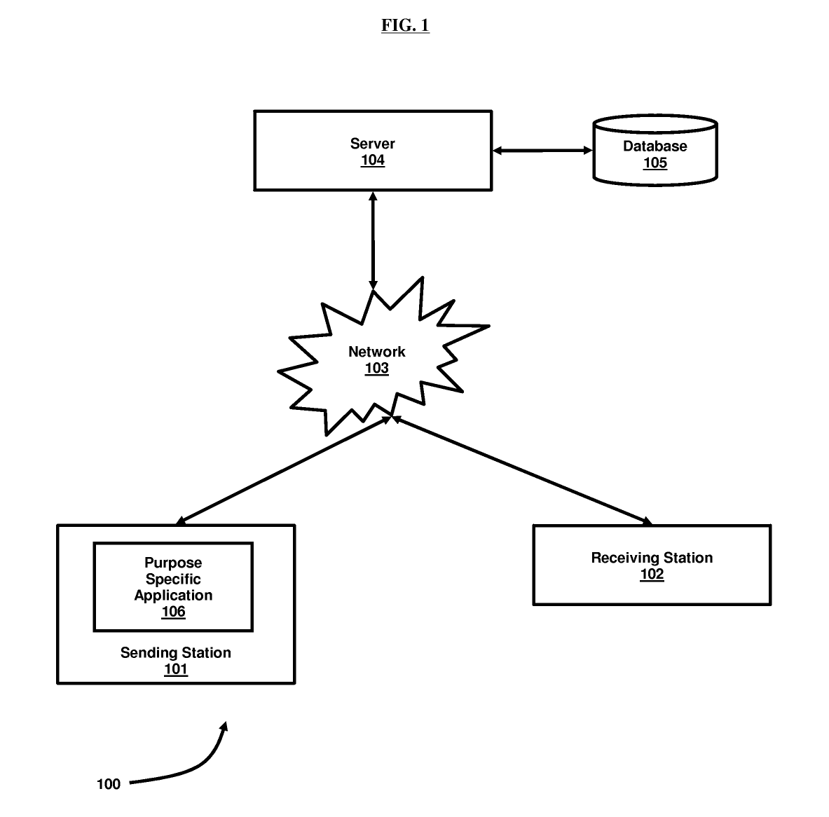

Disclosed herein are methods and systems for sending messages with a geographic location reference in the form of a location token. Referring now to the drawings, and more particularly to FIGS. 1 through 12, where similar reference characters denote corresponding features consistently throughout the figures, there are shown preferred embodiments.

FIG. 1 is a block diagram illustrating a system for sending a message along with a location token. The system comprises of a sending station 101, a receiving station 102, a server 104, and a database 105 in a communications network 103. The sending station 101 is a station that is used to send messages with one or more location tokens. The receiving station 102 is a station that is used to receive messages with one or more location tokens. The server 104 is a network component that is capable of at least generating location tokens for specified locations, sending and receiving messages that can be understood by the sending station and the receiving station, storing and retrieving at least information about location tokens using a database or using an encoding/decoding algorithm, and if required dereferencing a location using a location token. The database 105 is a data store of the server to store at least information about users and location tokens. In various embodiments, the database 105 may be internal to the server 104 as a storage module. In various embodiments, server 104 may be capable of receiving requests through circuit switched networks (for example, telecommunication networks) or packet switched networks (for example, Internet).

The sending station 101 further comprises of a purpose specific application 106 that facilitates the process of users selecting a location, and placing requests to the server for location tokens for the selection location. The purpose specific application 106 may place requests to the server 104 using an appropriate data connection depending on the environment. For example, in a computer network environment, a sending station 101 may use Internet connection to place requests to the server 104. In another example, in a cellular network environment, a sending station 101 may use GPRS connection to place requests to the server 104. In various embodiments, the purpose specific application may take the form of application software, device firmware, downloaded web browser script modules, or other software.

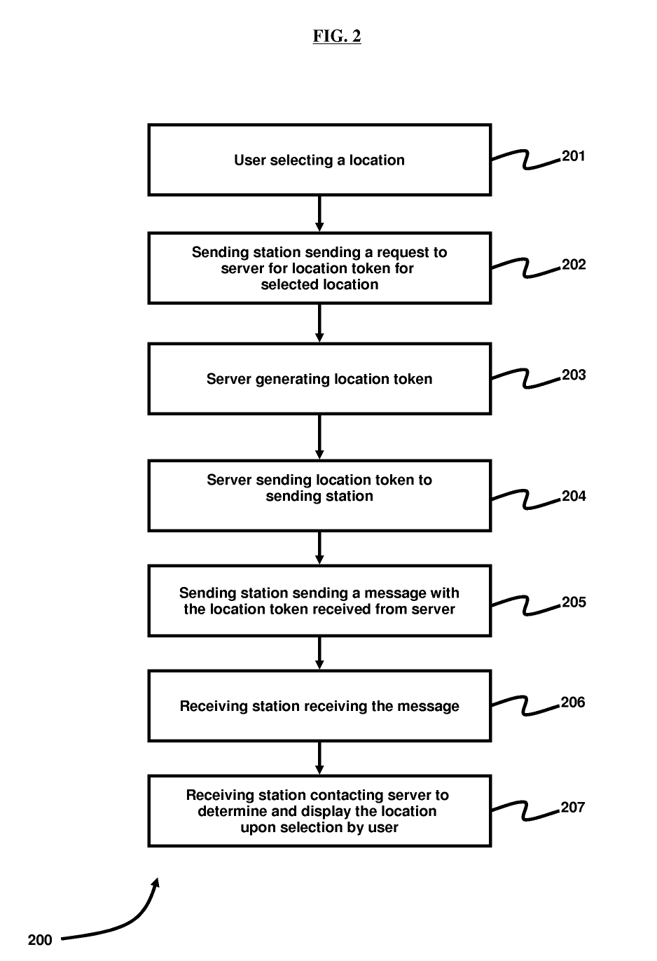

FIG. 2 is a flow diagram illustrating a method for sending a message with location in a communications network according. User selects (201) a location for sharing with another user. The location selected by user may be enabled through many ways including but not limited to using a GPS receiver in the handset to find current location, using a radio tower identifier to find current location, or using other geolocation methods to identify a location. The location may be any location and may not be related to the location of the user operating the sending station. Selection of a location may further be enabled by a purpose specific application 106 loaded onto the sending station 101. The purpose specific application 106 may enable a user to select a specific location using a map interface as shown by map applications like Google Maps. In some embodiments, the purpose specific application 106 may interact with an external application like Google maps to enable a user to select a specific location. Once a geographic location is selected, the purpose specific application 106 automatically gathers the information of the location as selected by the user, and sends (202) a request to the server 104 along with the location information for a location token to be generated for the location selected by the user. The server 104, upon receiving the request from the sending station, obtains the location information (like the latitude/longitude information or place of interest information) and generates (203) a location token for the location selected by the user. In a preferred embodiment, the location token generated is in the form of a URL (for example, http://www.wizi.com/x2j76au). The server 104 sends (204) a response to the request from the sending station 101 with location token. The purpose specific application 106 processes the response and automatically adds the received location token to a new message. In some embodiments, the purpose specific application 106 may also have messaging capabilities, and may use such messaging capabilities for creating and sending messages. In some other embodiments, the purpose specific application may invoke another messaging application for creating and sending a message. The user may then edit the message to include other information that he may want to include. The user operating the sending station 101 may then send (205) the message including the location token received from the server to a receiving station 102. Receiving station 102 receives (206) the message along with the location token from the sending station 101. The user operating the receiving station 102 clicks on the location token to view the location. The location token will be processed like any other URL by a web browser or by any other suitable application, and the location may be displayed using a maps application like Google maps.

In a preferred embodiment, the location token in the URL format (for example, http://www.wizi.com/x2j76au) comprises of two parts. The first part indicates the server (www.wizi.com) and the second short encoded part (x2j76au) of the URL is the string that refers to a particular location. The second part of the location token may be in the form of a random string, or an encoded string with a combination of user and/or location information in part or in whole.

In alternative embodiments, the server 104 may send the location token in a string format, equivalent to the second portion in the URL http://www.wizi.com/x2j76au. In such embodiments, there may be a purpose specific application loaded on the receiving station 102 capable of converting the location token from a string format to a URL format that may be used to access the location using the server 104 through an application like a web browser. In such embodiments, the purpose specific application loaded on the receiving station 102 may convert the location token in string format to a URL format before displaying the message in a message viewer. In some embodiments, the purpose specific application loaded on the receiving station 102 may have message display capabilities, and may use such message display capabilities to display the message in appropriate format. In some other embodiments, the purpose specific application loaded on to the receiving station 102 may use an external message display application available on the receiving station 102 to display the message.

In some embodiments, after generating a location token, the server 104 may store the location token in the database 105 for future retrieval. Users operating sending stations 101 may be registered users or unregistered users. If the user is a registered user, the server, while storing the location token in the database 105, may also associate the location token with the user operating the sending station from which the request was made. If the user is an unregistered user, the server while storing the location token, may also associate the location token with the unique identifier (like the unique identifier of the device) of the sending station 101.

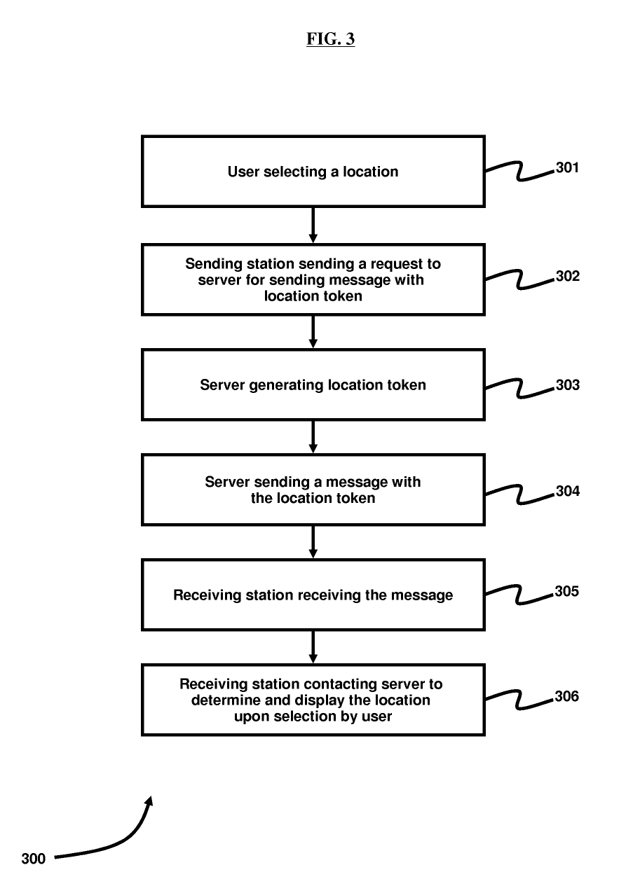

FIG. 3 is a flow diagram illustrating a method of sending a message along with a location token. FIG. 3 illustrates an alternative embodiment to the embodiment illustrated in FIG. 2. In the embodiment illustrated in FIG. 3, the server sends the message instead of the sending station 101 sending the message. According to the embodiment, user selects (301) a location for sharing with another user. Once a geographic location is selected, the purpose specific application 106 automatically gathers the information of the location selected by the user, and sends (302) a request to the server 104 along with the location information for a location token for the location selected by user to be generated and a message to be sent to a receiving station 102. The server, upon receiving the request from the sending station 101, obtains the location information (like the latitude/longitude information or place of interest information) from the request and generates (303) a location token for the location selected by the user. The server 104 creates a message, and sends (304) the message to the specified receiving station 102 with the location token included in the message. Receiving station 102 receives (305) the message along with the location token from the server 104. The user operating the receiving station 102 clicks on the location token to view (306) the location in an application like a web browser.

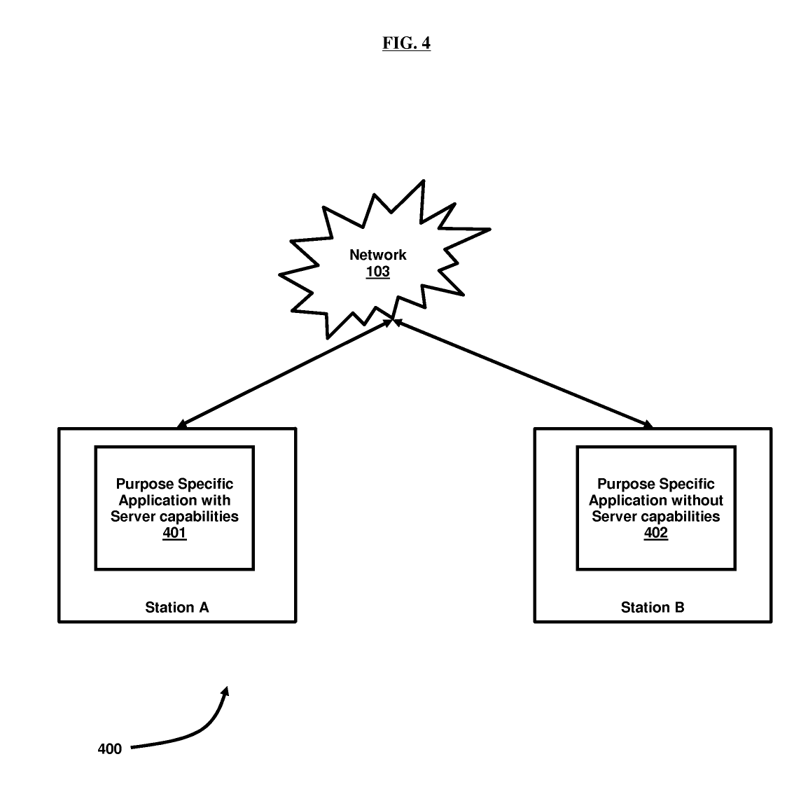

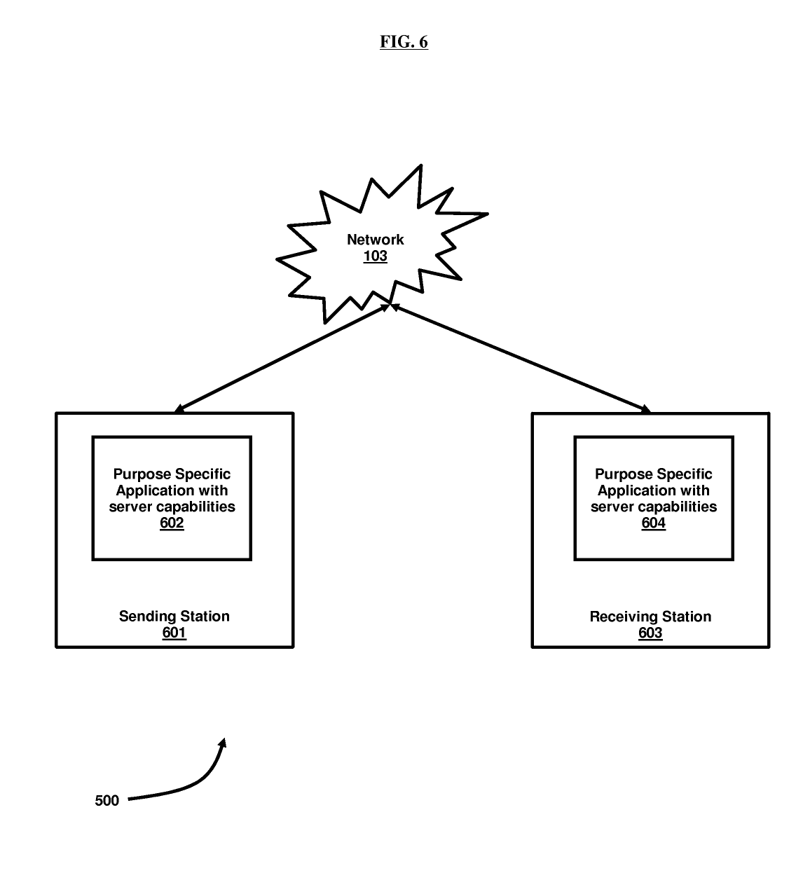

FIG. 4 and FIG. 6 are block diagrams illustrating alternative systems for sending a message along with a location token. FIG. 4 and FIG. 6 illustrate alternative embodiments to the embodiment illustrated in FIG. 1, where there is no server component that is external to the sending station and the receiving station, and where the sending station and the receiving station may communicate using a peer to peer network means for communication.

In the embodiment illustrated in FIG. 4, some or all of the capabilities of server are co-hosted within the purpose specific application 401 that is part of the station A, which might act as a sending or a receiving station. The capabilities of server co-hosted include at least the capability to accept a request for showing the location through a URL and to send a response with location information. In one example, such request may be sent as an http or https request, and the response may be sent as a corresponding http or https response.

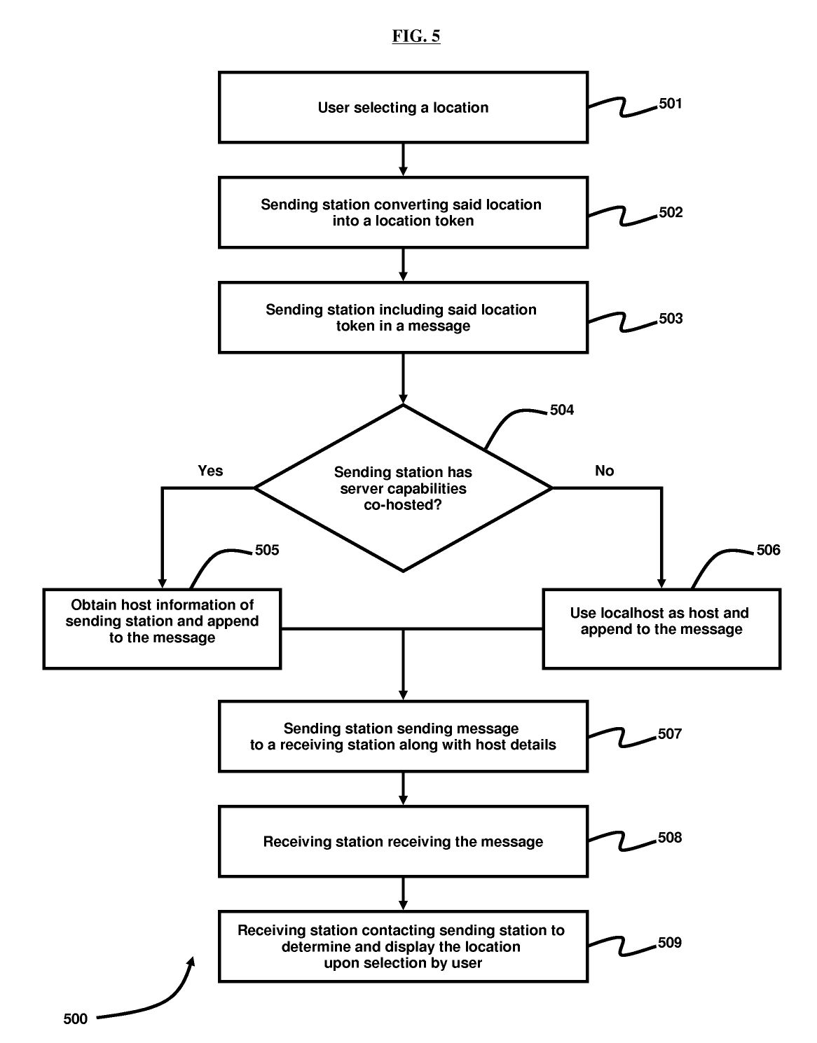

FIG. 5 is a flow diagram illustrating a method of sending a message along with a location token according to the embodiment illustrated in FIG. 4.

According to this embodiment, when station A is the sending station, user selects (501) a location using a sending station (station A). The purpose specific application 401 on the sending station (station A) automatically obtains the location information from user selection, and generates (502) a location token using the obtained location information. On generating the location token, the purpose specific application 401 creates a new message and adds (503) the location token to the new message. The user may then edit the message to add other information. User confirms the message to be sent. The purpose specific application on the sending station (station A) then checks (504) if the sending station (station A) has server capabilities. Since the sending station (station A) has the server capabilities, the sending station (station A) obtains and appends (505) the host information of the sending station (station A) along with the message, and sends (507) the message. Receiving station (station B) receives (508) the message along with location token and host information. The purpose specific application 402 on the receiving station (station B) formats (when required) the message so that the location token is in the URL format. The purpose specific application 402 formats (when required) the URL using the host information obtained from the sending station (station A). User then clicks on the URL to retrieve (509) location from the sending station (station A).

In some embodiments, the sending station (station A) may use another server (not shown in diagrams) as host. In such embodiments, receiving station (station B) contacts the server to obtain location information when a user clicks on the URL.

When station B is the sending station, user selects (501) a location using a sending station (station B). The purpose specific application 402 on the sending station (station B) automatically obtains the location information from user selection, and generates (502) a location token using the obtained location information. On generating the location token, the purpose specific application 402 creates a new message and adds (503) the location token to the new message. The user may then edit the message to add other information. User confirms the message to be sent. The purpose specific application on the sending station (station B) then checks (504) if the sending station has server capabilities. Since the sending station (station B) does not have the server capabilities co-hosted in it, the sending station (station B) appends (505) “localhost” host information (for example, a standard configuration like 127.0.0.1) to the message, and sends (507) the message. Receiving station (station A) receives (508) the message along with location token and host information. The purpose specific application 401 on the receiving station (station A) formats the message (when required) so that the location token is in the URL format. The purpose specific application 401 formats (when required) the location token using the host information obtained from the sending station (station B). User then clicks on the URL to retrieve (509) location from the sending station (station B).

In some embodiments, the sending station (station B) may use another server (not shown in diagrams) as host. In such embodiments, receiving station (station A) contacts the server to obtain location information when a user clicks on the URL.

In some embodiments, the sending station (station A, station B) may send the location token in URL format using the host information that the sending station (station A, station B) determines. In some other embodiments, the sending station (station A, station B) may send location token as a string, where the receiving station (station B, station A) formats the location token to URL format before displaying the message to the user operating the receiving station (station B, station A).

In the embodiment illustrated in FIG. 6, some or all of the capabilities of a server 104 are co-hosted in both the sending station 601 and the receiving station 603 in their respective purpose specific applications (602, 604). In some embodiments, the capabilities co-hosted in the sending station 601 and the receiving station 603 may be same. In some other embodiments, different capabilities of server 104 may be co-hosted in the sending station 601 compared to the capabilities of server 104 that are co-hosted in the receiving station 603. The capabilities of server 104 co-hosted include at least the capability to accept a request for showing the location through a URL and to send a response with location information. In one example, such request may be sent as an http or https request, and the response may be sent as a corresponding http or https response.

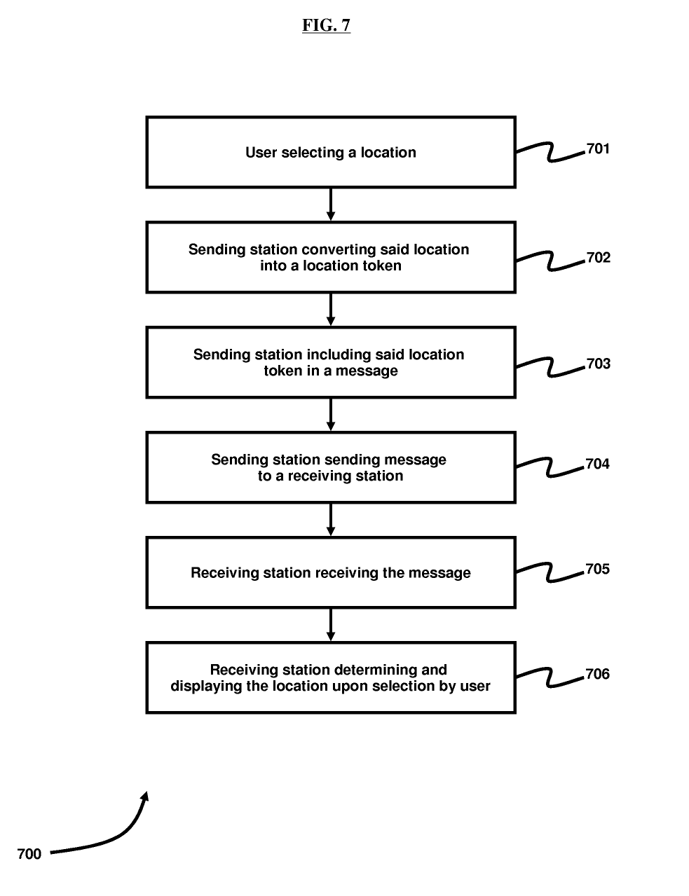

FIG. 7 is a flow diagram illustrating a method of sending a message along with a location token according to the embodiment illustrated in FIG. 6. According to the embodiment, user selects (701) a location using the sending station 601. The purpose specific application 602 on the sending station 601 automatically obtains the location information from user selection, and generates (702) a location token using the obtained location information. On generating the location token, the purpose specific application 602 creates a new message and adds (703) the location token to the new message. The user may further edit the message to add other information. The sending station 601 sends (704) the message with location token to the receiving station 603. Receiving station 603 receives (705) the message along with location token. The purpose specific application 604 on the receiving station 603 formats the message (when required) so that the location token is in the URL format. The purpose specific application 604 formats (when required) the URL using “localhost” host information since the receiving station 603 also has server capabilities co-hosted. User then clicks on the URL to retrieve (706) location.

In some embodiments, the sending station 601 may send location token in URL format with sending station 601 as host. The purpose specific application 604 on the receiving station 603 may use the same URL. In some other embodiments, the purpose specific application 604 on the receiving station 603 may check if the receiving station 603 has server 104 capabilities co-hosted. If the server 104 capabilities are co-hosted on the receiving station 603, the purpose specific application 604 on the receiving station 603 may present options to the user to choose the host that the user might want to use. In other embodiments, the purpose specific application 604 on the receiving station 604 may replace the host information in the URL received from the sending station 601 with the “localhost” host information without prompting the user operating the receiving station 603.

In some other embodiments, the sending station 601 may send location token as a string, where the receiving station 603 formats the location token to URL format before displaying the message to the user operating the receiving station.

In various embodiments location specified may be dynamic, static, implied, by an entered address, selected on map, taken from an address book, taken from user's current location as determined by GPS, taken from user's current location as determined by radio signal tower identifier or other radio device like Bluetooth, WiFi or WiMax. In various embodiments, user's current location may be determined using radio signal strength.

In some embodiments, the location may be a fixed location, corresponding to sender's current location, or to any location, such as meeting location, chosen by the sender. In this embodiment parties gain convenience and flexibility as they are able to designate a location of mutual interest at will without any restriction imposed by the system.

In some other embodiments, the location may be a dynamically altering place, usually corresponding to sender's then current location, but potentially attached to some other moving object, which object can be simulated. Such embodiment provides quicker convergence in rendezvous application. The fact that the movement can be simulated facilitates guided tours, orientation games, and on-floor supermarket marketing campaigns, among many other useful applications. Tokens representing dynamically altering locations may be dereferenced by posting a request to a server, e.g. by a browser posting a request to a web server or by a purpose specific application posting a request to a server. Such server may maintain dynamically variable location information in a database, retrievable by reference to the token.

In various embodiments request to view location can be made from an email application, SMS application, web browser, mobile web browser, mapping application software, and location sharing software among others.

In various embodiments sending station and receiving station may be one of a web browser, a personal computer, and a mobile communication device, or any other suitable portable and non-portable communication device.

In some embodiments a location token in the short form coded URL can be suffixed by a descriptive string, e.g. http://wizi.com/x2j75c/Cafe_Paris. This formulation allows URL to be meaningfully understood by humans while at the same time ensuring accurate processing. In such cases, it may be possible to successfully dereference a damaged URL, as is often the case when URLs are transported in email.

In one embodiment, the short form coded URL has properties of a randomly generated string that is difficult to guess, allowing it to act as an authorization token, i.e. a bearer token, for accessing a resource. In one embodiment the resource is a visualization of the location on map, but other embodiments may include aural or machine readable renderings. The resource can describe any useful information including location, route to location, properties of location, or properties of sender. All these ramifications of resource enable recipient of the short form coded URL to act on the information more efficiently, more timely, and more to the point. This also benefits the sender as accurate results eliminate confusion and waste of time. In some embodiments, the randomness and difficult to guess properties of the short form encoded URL may be used to preserve the anonymity, conditional anonymity, or pseudonymity of the sender. This is desirable in applications where sender and receiver engage in a negotiation process where each party progressively reveals more details about himself.

In one embodiment, the fact that short form coded URL's construction does not rely on identity of the creator, enables anonymous, conditionally anonymous, pseudonymous, or unregistered users to send descriptive information about geographic location without loosing their original privacy properties. Such guarantee leads to clear benefits to the user and consequently lowers the barriers to use and increases the volume of use.

In some embodiments, the message sent may contain an invitation for the receiver to join the service as a registered user. Registration provides benefits to recurring user of the service, such as ability to track who is using the location data, or to track messages already sent, or to compile list of recipients that can be reused from a message to another. Registered user may also control privacy settings and access control rights attached to the short form coded URLs that he has created.

In some embodiments, the message sent may contain an invitation to form location sharing or presence sharing relationship with the sender. Such relationship permits increased convenience between the parties in sharing these aspects. Relationship is also a convenient vehicle for each party to set permissions and audit the usage of the service.

In some embodiments, the message sent may contain an invitation to form contact sharing and communications relationship. Such relationship is beneficial to both parties in increasing convenience of communication.

In some embodiments, the location is revocable. After revocation, the recipients of the URL can no longer discover the location. The revocation may happen either by user explicitly sending a command to the server along with the token originally generated to identify the location, or after a pre-determined expiration period. The expiration period may be pre-determined by the server for all users or the expiration period may be configurable by each user through his station according to his preferences using a purpose specific application or using a standard messaging means like email or SMS. The revocation of a location based on an expiration period allows sharing a location for a limited period of time only. Since the location will no longer be available on the server after an expiration period, the privacy of individuals who share their location is ensured. Further benefits of revocation of location include: ability to eliminate erroneous location information, ability to limit access to the location as crowd builds up, ability to conduct marketing games where only some number of first punters can participate, and ability to limit inadvertent disclosure, among others.

In a preferred embodiment the server 103 is an external server available over the Internet. However, a skilled person in the art would realize the fact that the some or all functions performed by server may be implemented on sending station or receiving station or distributed among sending station and receiving stations as required.

In some embodiments, when a user operating a receiving station cannot access server using a location in the form of a URL, a purpose specific application on the receiving station may be able to short encoded part of the URL to obtain basic location information (like latitude/longitude information, name of location). The short encoded string part may comprise of basic location information, user information, or a combination thereof.

### EXAMPLE IMPLEMENTATION

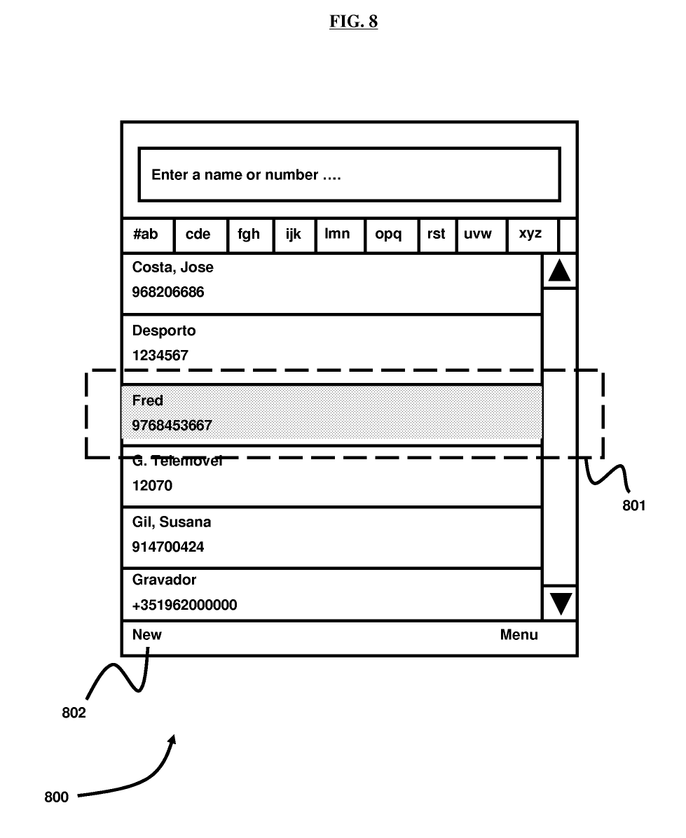

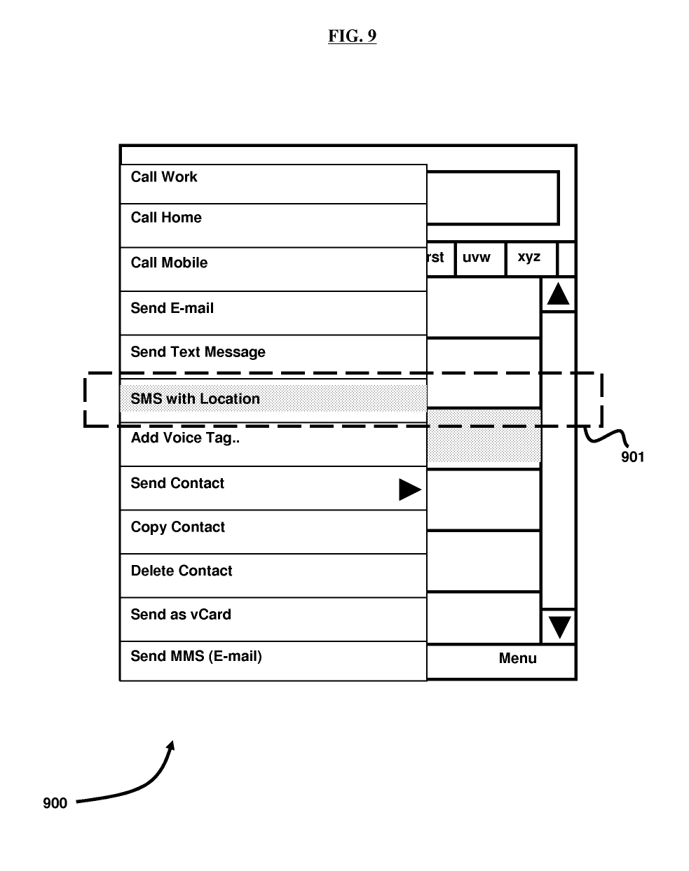

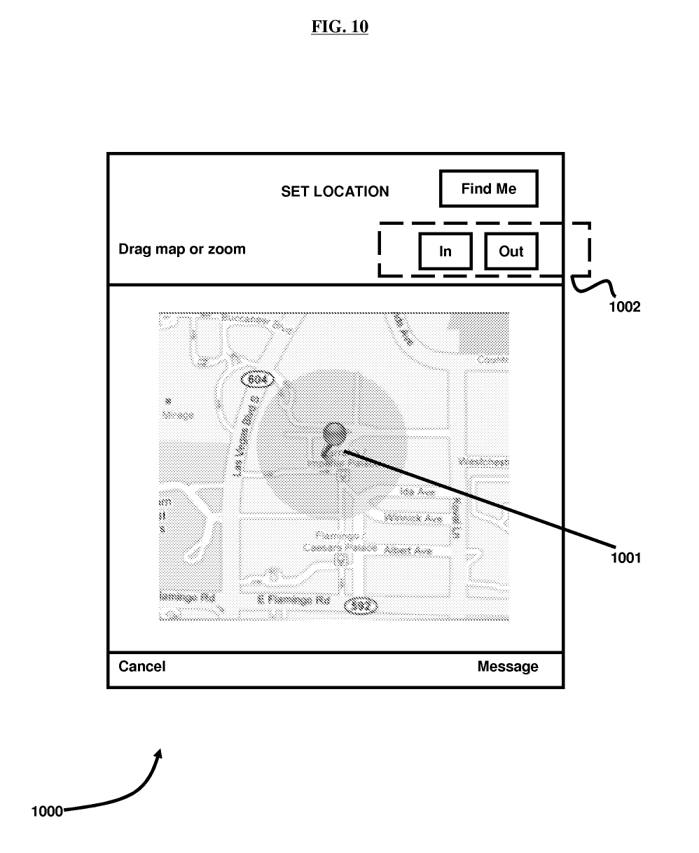

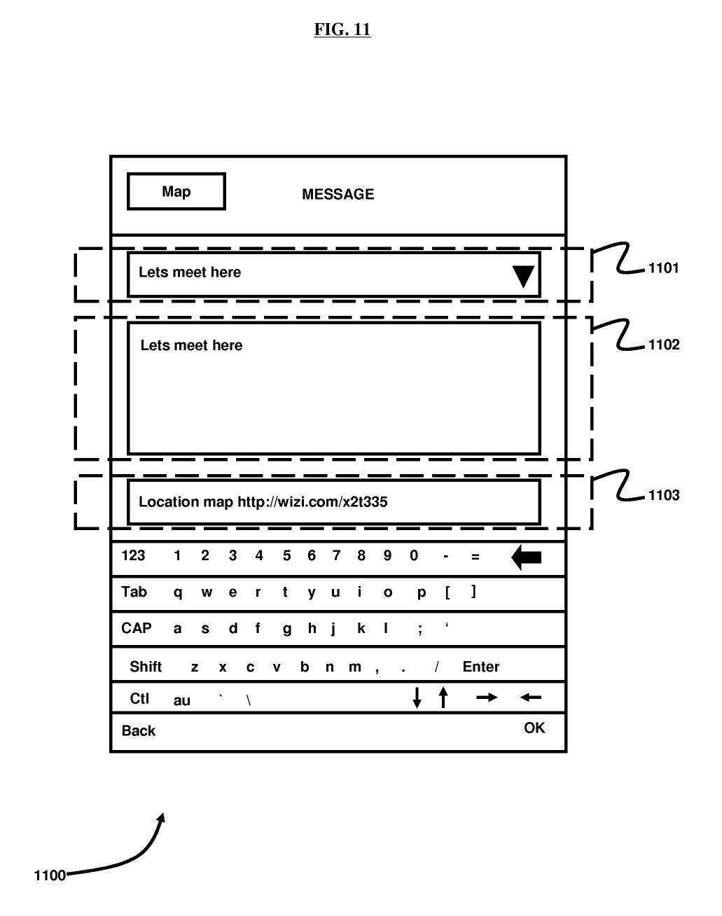

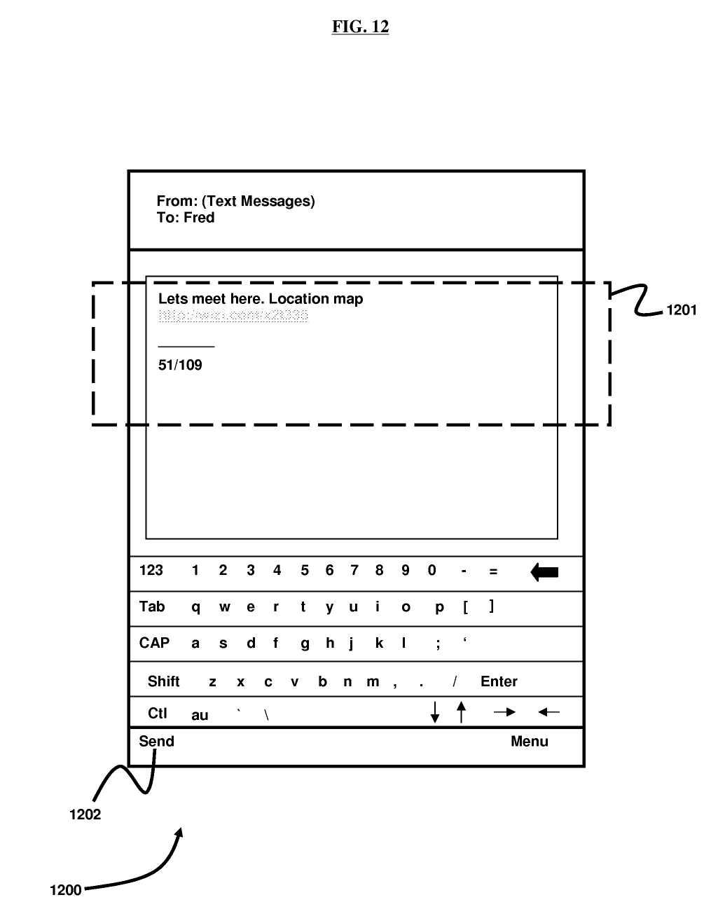

FIGS. 8 to 12 illustrate an example implementation on sending station according to various embodiments. FIG. 8 shows the contact list on a sending station. User selects one or more contacts 801 or a group of contacts to send a message. User may launch a new menu 802 to create a message. FIG. 9 shows the step of user choosing to send a new message in the form of SMS with location 901. Upon choosing the SMS with location 901, there may be many possible implementations of how a location may be chosen. The example implementation shows selecting a location using location maps (example, Google maps) in FIG. 10. As shown in FIG. 10 user may choose a location 1001 by pointing to a particular area on the map. The user may also move the map or zoom in and zoom out 1002 to pin point a location on the map. In other embodiments, it is also possible to select location from a menu comprising pre-defined locations chosen based on interests of users, user behavior, locations added by user for future reference, user's current location (using location maps or any suitable means) and so on. FIG. 11 shows the step of user typing a message 1102. The user may choose a message from existing set of previously sent messages or message templates 1101. By the time user arrives to this screen, it can be noted that the sending station 101 had already placed a request to a location token service for providing location token for the location chosen by the user. The location token service may be a service residing on a remote server 104 or may be a service on the sending station. The location token may be provided by the location token service in the form of a URL (http://wizi.com/x2t335). The same URL is included as part of the message. While the user is typing his message, the location token may be displayed below the message text box 1103 as shown in FIG. 11. FIG. 12 shows the next step where the message 1201 is ready to be sent by using the send button 1202. The sending station 101 has included the location token in the form of URL generated for the location token. In other embodiments, the location token may be in other formats. When received, the recipient may see a message like “Let's meet here. Location map http://wizi.com/x2j75c”. The user clicks on the URL and the recipient's phone automatically displays a map of the selected location.

An advantage provided by the embodiments herein is that they provide methods and systems to communicate a detailed geographic reference, a map, or a large amount of data of any type to be communicated in a short messaging service like SMS, through use of a short reference like a location token.

Another advantage provided by the embodiments herein is that they allow a dynamically changing piece of data, such as the live location of the sender as the data changes from time to time, to be communicated in a single SMS, without the need to send new messages to update the data (for example, location) as it changes.

Another advantage provided by the embodiments herein is that by modifying only sending station to be equipped with specialized software, one could send information (fixed or live geographic reference, etc) that could retrieved and displayed by a receiving station with only a web browser.

The embodiments herein can take the form of an entirely hardware embodiment, or an embodiment including both hardware and software elements. The portions that are implemented in software include but are not limited to, firmware, resident software, microcode, etc.

Furthermore, the sending station, the receiving station, the server and, the database as disclosed herein in various embodiments can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method for sending a message with location token in a communication network, said network comprising at least a sending station, and a receiving station, said method comprising:
user operating said sending station selecting a location;
said sending station generating a location token using said selected location;
said sending station adding said location token to said message;
said sending station appending host information of said sending station to said message;
said sending station sending said message with said generated location token and said host information;
said receiving station receiving said message; and
user operating said receiving station retrieving location.

2. The method as claimed in claim 1, wherein said method further comprises of said receiving station formatting said generated location token into URL format, where said generated location token is not in a URL format.

3. The method as claimed in claim 1, wherein said location token is a URL where said URL comprises of a short encoded string, and where said short encoded string comprises of
location information; and
user information.

4. The method as claimed in claim 1, wherein said location token comprises of a short encoded string, said short encoded string may include one among or a combination of
location information; and
user information.

5. The method as claimed in claim 1, wherein said method further comprising adding a descriptive string as suffix to location token.

6. The method as claimed in claim 1, wherein said method further comprising adding an invitation to message for the receiver to join the service as a registered user.

7. The method as claimed in claim 1, wherein said method further comprising adding an invitation to said message to form location sharing or presence sharing relationship with the sender.

8. The method as claimed in claim 1, wherein said method further comprising adding an invitation to said message to form contact sharing and communications relationship.

9. The method as claimed in claim 1, wherein said location is a fixed place.

10. The method as claimed in claim 1, wherein said location is a dynamically altering place.

11. A method for sending a message with location token in a communication network, said network comprising at least a sending station, and a receiving station, said method comprising:
user operating said sending station selecting a location;
said sending station generating a location token using said selected location;
said sending station adding said location token to said message;
said sending station appending localhost information to said message;
said Sending station sending said message with said generated location token and said localhost information;
said receiving station receiving said message; and
user operating said receiving station retrieving location.

12. The method as claimed in claim 11, wherein said method further comprises of said receiving station formatting said generated location token into URL format, where said generated location token is not in a URL format.

13. The method as claimed in claim 11, wherein said location token is a URL where said URL comprises of a short encoded string, and where said short encoded string comprises of
location information; and
user information.

14. The method as claimed in claim 11, wherein said location token comprises of a short encoded string, said short encoded string may include one among or a combination of
location information; and
user information.

15. The method as claimed in claim 11, wherein said method further comprising adding a descriptive string as suffix to location token.

16. The method as claimed in claim 11, wherein said method further comprising adding an invitation to message for the receiver to join the service as a registered user.

17. The method as claimed in claim 11, wherein said method further comprising adding an invitation to said message to form location sharing or presence sharing relationship with the sender.

18. The method as claimed in claim 11, wherein said method further comprising adding an invitation to said message to form contact sharing and communications relationship.

19. The method as claimed in claim 11, wherein said location is a fixed place.

20. The method as claimed in claim 11, wherein said location is a dynamically altering place.

21. A method for sending a message with location token in a communication network, said network comprising at least a sending station, and a receiving station, said method comprising:
user operating said sending station selecting a location;
said sending station generating a location token using said selected location;
said sending station adding said location token to said message;
said sending station sending said message with said generated location token;
said receiving station receiving said message; and
user operating said receiving station retrieving location.

22. The method as claimed in claim 21, wherein said method further comprises of said receiving station formatting said generated location token into URL format, where said generated location token is not in a URL format.

23. The method as claimed in claim 21, wherein said location token is a URL where said URL comprises of a short encoded string, and where said short encoded string comprises of
location information; and
user information.

24. The method as claimed in claim 21, wherein said location token comprises of a short encoded string, said short encoded string may include one among or a combination of
location information; and
user information.

25. The method as claimed in claim 21, wherein said method further comprising adding a descriptive string as suffix to location token.

26. The method as claimed in claim 21, wherein said method further comprising adding an invitation to message for the receiver to join the service as a registered user.

27. The method as claimed in claim 21, wherein said method further comprising adding an invitation to said message to form location sharing or presence sharing relationship with the sender.

28. The method as claimed in claim 21, wherein said method further comprising adding an invitation to said message to form contact sharing and communications relationship.

29. The method as claimed in claim 21, wherein said location is a fixed place.

30. The method as claimed in claim 21, wherein said location is a dynamically altering place.

31. A method for sending a message with location token in a communication network, said network comprising at least a sending station, a receiving station, a server, and a database said method comprising:
user operating said sending station selecting a location;
said sending station requesting said server to generate a location token for said selected location;
said server generating a location token for said selected location;
said server returning said location token to said sending station;
said sending station including said location token in said message;
said sending station sending said message with said generated location token; and
said receiving station receiving said message;
user operating said receiving station retrieving location.

32. The method as claimed in claim 31, wherein said method further comprises of said receiving station formatting said generated location token into URL format, where said generated location token is not in a URL format.

33. The method as claimed in claim 31, wherein said location token may be stored for future retrieval.

34. The method as claimed in claim 31, wherein said location token is a URL where said URL comprises of a short encoded string, and where said short encoded string comprises of
location information; and
user information.

35. The method as claimed in claim 31, wherein said location token comprises of a short encoded string, said short encoded string may include one among or a combination of
location information; and
user information.

36. The method as claimed in claim 31, wherein said method further comprising adding a descriptive string as suffix to location token.

37. The method as claimed in claim 31, wherein said method further comprising adding an invitation to message for the receiver to join the service as a registered user.

38. The method as claimed in claim 31, wherein said method further comprising adding an invitation to said message to form location sharing or presence sharing relationship with the sender.

39. The method as claimed in claim 31, wherein said method further comprising adding an invitation to said message to form contact sharing and communications relationship.

40. The method as claimed in claim 31, wherein said location is a fixed place.

41. The method as claimed in claim 31, wherein said location is a dynamically altering place.

42. The method as claimed in claim 31, wherein said method further comprising user operating said sending station sending a command to the server along with said location token to revoke said location token immediately.

43. The method as claimed in claim 31, wherein said method further comprising user operating said sending station sending a command to the server along with said location token to revoke said location token after a pre-determined expiration period.

44. A method for sending a message with location token in a communication network, said network comprising at least a sending station, a receiving station, a server, and a database said method comprising:
user operating said sending station selecting a location;
said sending station requesting said server to send said message to said receiving station along with a location token for said selected location;
said server generating a location token for said selected location;
said server including said location token in said message;
said server sending said message with said generated location token;
said receiving station receiving said message; and
user operating said receiving station retrieving location.

45. The method as claimed in claim 44, wherein said method further comprises of said receiving station formatting said generated location token into URL format, where said generated location token is not in a URL format.

46. The method as claimed in claim 44, wherein said location token may be stored for future retrieval.

47. The method as claimed in claim 44, wherein said location token is a URL where said URL comprises of a short encoded string, and where said short encoded string comprises of
location information; and
user information.

48. The method as claimed in claim 44, wherein said location token comprises of a short encoded string, said short encoded string may include one among or a combination of
location information; and
user information.

49. The method as claimed in claim 44, wherein said method further comprising adding a descriptive string as suffix to location token.

50. The method as claimed in claim 44, wherein said method further comprising adding an invitation to message for the receiver to join the service as a registered user.

51. The method as claimed in claim 44, wherein said method further comprising adding an invitation to said message to form location sharing or presence sharing relationship with the sender.

52. The method as claimed in claim 44, wherein said method further comprising adding an invitation to said message to form contact sharing and communications relationship.

53. The method as claimed in claim 44, wherein said location is a fixed place.

54. The method as claimed in claim 44, wherein said location is a dynamically altering place.

55. The method as claimed in claim 44, wherein said method further comprising user operating said sending station sending a command to the server along with said location token to revoke said location token immediately.

56. The method as claimed in claim 44, wherein said method further comprising user operating said sending station sending a command to the server along with said location token to revoke said location token after a pre-determined expiration period.

57. A sending station for sending a message with location token in a communications network, said network further comprising at least a receiving station, and a server, said sending station comprising:
means for user operating said sending station to select a location;
means for sending request to said server to generate location token for said selected location;
means for receiving said location token generated by said server;
means for including said location token in said message; and
means for sending said message to said receiving station.

58. A sending station for sending a message with location token in a communications network, said network further comprising at least a receiving station, said sending station comprising:
means for user operating said sending station to select a location;
means for generating location token for said selected location;
means for including said location token in said message; and
means for sending said message to said receiving station.

59. The sending station as claimed in claim 58, wherein said sending station further comprising
means for accepting a request to dereference a location using a location token; and
means for sending a response to said request with dereferenced location information.

60. The sending station as claimed in claim 58, wherein said location token is a URL where said URL comprises of a short encoded string, and where said short encoded string comprises of
location information; and
user information.

61. The sending station as claimed in claim 58, wherein said location token comprises of a short encoded string, said short encoded string may include one among or a combination of
location information; and
user information.

62. A receiving station for receiving a message with location token in a communications network, said network further comprising at least a sending station, and a server, said receiving station comprising:
means for receiving a message with location token; and
means for requesting a host to dereference location based on said location token.

63. The receiving station as claimed in claim 62, wherein said receiving station further comprising means for formatting a location token into URL format when said location is not in a URL format.

64. The receiving station as claimed in claim 62, wherein said receiving station further comprising means to dereference location using said location token.

65. The receiving station as claimed in claim 62, wherein said host is a server.

66. The receiving station as claimed in claim 62, wherein said host is a sending station.

67. The receiving station as claimed in claim 62, wherein said host is a receiving station.

68. A server for sending a message with location token in a communications network, said network further comprising at least a sending station, a receiving station, and a database, said server comprising:
means for accepting requests to generate location tokens for specified locations;
means for generation location tokens for specified locations; and
means for sending responses to said requests with said location token.

69. The server as claimed in claim 68, wherein said server further comprising means for sending a message along with said location token to said receiving station.

70. The server as claimed in claim 68, wherein said server further comprising means for adding said generated location tokens in said database for future retrieval.

71. The server as claimed in claim 68, wherein said location token is a URL where said URL comprises of a short encoded string, and where said short encoded string comprises of
location information; and
user information.

72. The server as claimed in claim 68, wherein said location token comprises of a short encoded string, said short encoded string may include one among or a combination of
location information; and
user information.

73. A server for sending a message with location token in a communications network, said network further comprising at least a sending station, a receiving station, and a database, said server comprising:
means for accepting requests to dereference location using a location token;
means for dereferencing location using said location token; and
means for sending responses to said requests with said location information.
